(19) United States
(12) Patent Application Publication
(10) Pub. No.: US 2025/0111219 A1
(43) Pub. Date: Apr. 3, 2025

(54) MULTI-FUNCTIONAL INTEGRATED PHOTONIC NEURAL NETWORKS AND PROCESSING DEVICES

(71) Applicant: KOC UNIVERSITESI, Istanbul (TR)

(72) Inventors: Emir Salih Magden, Istanbul (TR); Aycan Deniz Vit, Istanbul (TR); Kazim Gorgulu, Istanbul (TR); Ali Najjar Amiri, Istanbul (TR)

(73) Assignee: KOC UNIVERSITESI, Istanbul (TR)

(21) Appl. No.: 18/904,090

(22) Filed: Oct. 2, 2024

(30) Foreign Application Priority Data
Oct. 2, 2023 (TR) 2023/012306

(51) Int. Cl. G06N 3/067; G06N 3/04

(52) U.S. Cl. CPC G06N 3/0675; G06N 3/04

(57) ABSTRACT

The provided is a multi-functional integrated photonic neural network processing device, including: an input layer consisting of a series of waveguides configured to receive incoming optical signals (input array); an interferometer layer connected to the input layer comprising Mach-Zehnder Interferometers (MZIs) configured to apply linear transformations to a series of optical signals received from the input; an output layer connected to the interferometer layer comprising a series of waveguides configured to direct the optical signals from the interferometer layer to the output (output array); a pair of couplers and a pair of phase shifters located on each Mach-Zehnder Interferometer (MZI); and each phase shifter comprising a waveguide with an adjustable width and an adjustable length.

### CROSS-REFERENCE TO THE RELATED APPLICATIONS

This application is based upon and claims priority to Turkish Patent Application No. 2023/012306, filed on Oct. 2, 2023, the entire contents of which are incorporated herein by reference.

### TECHNICAL FIELD

This invention relates to the design of complex and multi-functional photonic devices using integrated photonic neural networks.

### BACKGROUND

The rapidly increasing data generation and transmission speeds have made the use of integrated photonic systems indispensable in modern communication and computing technologies. The development of these technologies necessitates the design of complex and multi-functional photonic devices. Optimization of these devices, which can consist of thousands of design parameters, cannot be achieved through a brute-force search method in the parameter space. There is a need for a method that can improve the performance of these devices to approach physical limits while making the design process time-efficient. Mach-Zehnder Interferometer (MZI)-based integrated photonic neural networks hold promise in areas such as photonic processors requiring linear transformations, programmable optical circuits, and optical signal processing. These MZI-based integrated photonic neural networks typically consist of MZI layers arranged in a specific sequential manner.

Traditionally, the design process of photonic devices involves physics-based analytical methods, practical experiences, and scientific intuitions. However, for complex structures, these methods are cumbersome and often insufficient. Therefore, iterative optimization techniques are used in the design of such complex structures. In the known state of the art, efforts aim to achieve the desired optical output by adjusting the dimensional parameters of classical structures such as ring resonators, power splitters, and interferometers. In such structures, a limited number of variables, such as waveguide width and coupler length, are optimized. Another method in the known state of the art involves designing optical structures using QR-code-like patterns, where pixels of 100-200 nm are etched based on the optimization results. By increasing the degrees of freedom in the design, more complex optical outputs are intended to be achieved with a compact structure. Additionally, it is known that photonic devices can be designed using deep neural networks. In this method, a deep learning model is created using datasets consisting of thousands of samples where the optical response is mapped to the device's geometric parameters. Subsequently, this model is used to obtain device geometries that will produce the desired optical response.

In the U.S. Pat. No. 11,656,337B2, which is part of the known state-of-the-art, a photonic device for processing optical signals within an integrated optical path is discussed.

In another U.S. Pat. No. 11,334,107B2, also part of the known state-of-the-art, optical neural networks comprising interconnected MZIs arranged in multiple columns are mentioned. It is also noted that each MZI includes a pair of couplers and a pair of phase shifters.

### SUMMARY

This invention aims to design complex and multi-functional photonic devices. In the known state of the art, inverse design methods have been widely used for this purpose. However, these structures require much longer simulation times or are difficult to fabricate because they are composed of very small building blocks. Due to these problems with inverse-designed devices, programmable photonic devices have been proposed for the design of complex and multi-functional photonic devices. These structures, typically consisting of sequentially arranged MZI units, include adjustable phase shifters. By controlling each phase element in a circuit, the circuit is configured to perform a specific function. These phase shifters are adjusted using active methods such as thermo-optic or electro-optic techniques. With a thermo-optic phase shifter, the temperature of the waveguide is controlled using heaters placed on or beside the waveguide, thereby controlling the optical distribution properties of the waveguide based on this temperature. The heater is operated by passing current through an electrical circuit. With an electro-optic phase shifter, the carrier concentration in a waveguide made of doped semiconductor is manipulated by applying an electrical voltage, thereby controlling the optical distribution properties of the waveguide. Both of these phase shifters use only one parameter, the applied electrical voltage, while operating. Therefore, a photonic neural network using such a structure as a phase shifter unit offers only one optimizable parameter per phase shifter. Additionally, these phase shifters consume electrical energy.

QR-code-like structures in the known state of the art do not provide the desired performance, and optimizing these structures can take days or even weeks. Furthermore, while higher-resolution irregular structures perform well, fabricating these structures, which consist of 10-20 nm pixels, is very challenging. In contrast, the integrated photonic neural network processing device of the present invention can be easily manufactured in a standard CMOS (Complementary Metal Oxide Semiconductor) foundry. For successful photonic device design using neural networks, it is necessary to create a dataset consisting of thousands of samples. These samples are often obtained using numerical methods such as FDTD (Finite-Difference Time-Domain), which require a lot of time. Another problem is that the structures to be obtained with the created model must resemble the structures in the dataset used to create the model. It is not possible to successfully obtain the design of an entirely different structure that the model is not familiar with. In contrast, the integrated photonic neural network processing device of the present invention can create structures of any complexity in a much more time-efficient manner.

The aim of the invention is to realize an integrated photonic neural network processing device that allows the wideband design of complex and multi-functional devices without using any active method by optimizing the width for phase adjustment and without limiting the number of control points where phase adjustment is performed, thereby allowing the number of optimizable parameters to be unrestricted.

The multi-functional integrated photonic neural network processing device of the present invention includes two couplers and two phase shifters for each MZI. The couplers enable the splitting of incoming light into two different paths or the merging of light from two paths. The phase of the light in each path is adjusted by the phase shifters. Phase shifters that can be controlled throughout the entire network allow for the desired linear transformation between the input and output.

The integrated photonic neural network processing device of the present invention comprises a sequence of Mach-Zehnder Interferometers arranged in an order. The phase shifters consist of tunable waveguides with adjustable widths. Changing the width of the waveguide in the phase shifter section creates a phase mismatch between the electromagnetic waves in the different arms of the coupler, which affects how the next coupler splits or merges the electromagnetic waves. Because of this phase mismatch, the electromagnetic waves at the next coupler are adjusted accordingly. Programming an integrated photonic neural network composed of sequential Mach-Zehnder Interferometers (MZIs) for a completely specific purpose (changing the waveguide widths in the phase shifter regions) results in a highly multivariate optimization problem. Therefore, the waveguide width values in the phase shifter regions are solved by physically modeling them with various artificial intelligence algorithms. As a result, purpose-specific integrated photonic neural networks are designed by an artificial intelligence algorithm in a much shorter time compared to human design and computation times. Thanks to the invention, integrated photonic neural networks and processing devices of desired lengths, widths, and purposes can be developed using Mach-Zehnder Interferometers and phase shifter blocks, which are the fundamental building blocks of the invention.

The integrated photonic neural network processing device of the present invention provides the designer with much greater freedom compared to the applications in the known state of the art. The designer can increase or decrease the size and the number of design parameters of the integrated photonic neural network processing device according to the requirements of the intended device. This allows for the design of both simple and much more complex structures.

Thanks to the invention, a photonic neural network processing device is obtained in which the number of optimizable parameters can be determined by the user, the number of parameters (width control points in the phase shifters) can be easily increased for the design of multi-functional optical devices, and no energy is consumed during operation.

### BRIEF DESCRIPTION OF THE DRAWINGS

Applications of the multi-functional integrated photonic neural network and its processing device are shown in various figures, including:

FIG. 1: A diagram showing the components of the multi-functional, scalable photonic neural network of the present invention.

FIG. 2: A top view of an optimizable waveguide in the photonic neural network of the present invention.

FIG. 3: A diagram showing an application of the photonic neural network of the present invention with two inputs/outputs and five layers.

FIG. 4: A diagram showing an application of the photonic neural network of the present invention performing multiple functions simultaneously.

FIG. 5: A diagram showing the iteration process of an adjustable-width waveguide in the photonic neural network of the present invention.

FIG. 6: A diagram showing the phase profiles of waveguides with adjustable widths and those with fixed widths.

FIG. 7: A diagram illustrating the effect of network size on the performance of fabrication-tolerant and non-tolerant splitters. The figure plots the splitting imbalance from a 50% splitting ratio under various fabrication variations, demonstrating how network scalability impacts splitter reliability and performance.

FIG. 8: A diagram showing electric field intensity for Transverse Electric (TE) and Transverse Magnetic (TM) polarizations at 1500 nm and 1600 nm wavelengths. The simulations show that light is evenly split between the two output ports for TE and TM polarizations, highlighting the device's polarization-independent splitting capabilities.

FIG. 9: A comparative analysis of output ports displaying normalized transmission spectra for the fabricated and experimentally measured duplexer. The figure includes the simulated transfer matrix and 3D-FDTD simulation results, providing a comprehensive overview of the duplexer's performance and validation against theoretical models.

FIG. 10: Dispersion profile of a 3-port network optimized to achieve step-like dispersion characteristics. The figure depicts the dispersion engineering achieved through precise waveguide dimension adjustments, illustrating how the network manipulates signal dispersion for enhanced telecommunication applications.

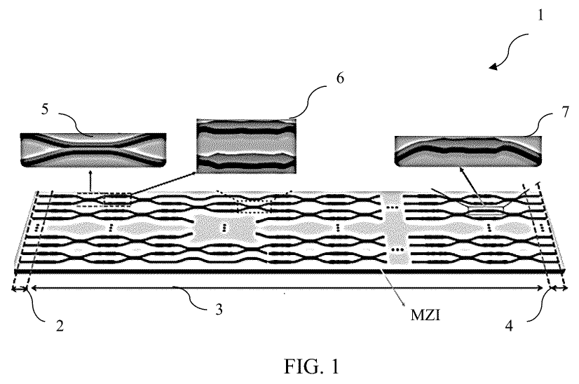

The reference numbers in the figures correspond to the following:
1. Photonic neural network device
2. Input layer
3. Interferometer layer
4. Output layer
5. Coupler
6. Phase shifter
7. Waveguide
8. Fabrication tolerant power distribution
9. Polarization-agnostic power splitting
10. Duplexer
11. Step-like dispersion profile
MZI: Mach-Zehnder Interferometers
KN: Control point
G: Width
L: Length

### DETAILED DESCRIPTION OF THE EMBODIMENTS

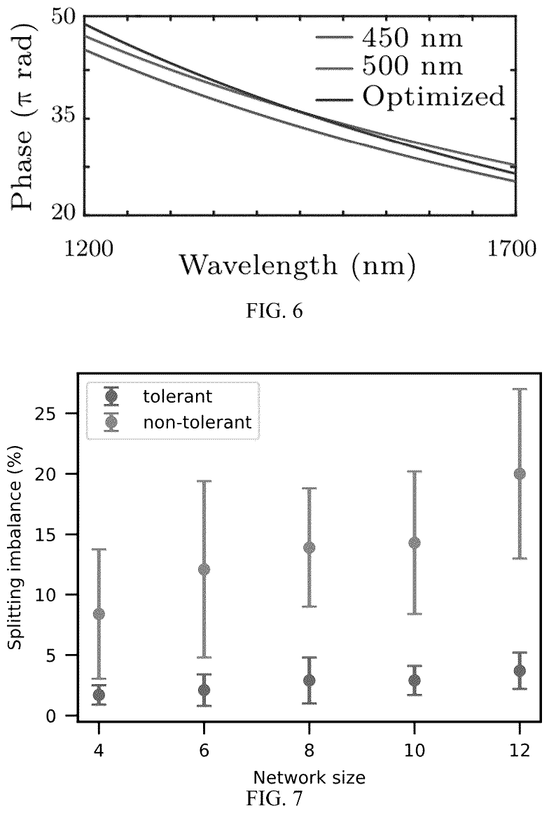

The widths (G) of the waveguides (7) can be calculated using an optimization algorithm suitable for the user's needs and optimization parameters. Light present in the waveguide (7) continues to propagate without power loss even if the width (G) of the waveguide (7) changes. In a fixed waveguide (7), light propagates without changing its dispersion properties. However, the propagation characteristics of light in a waveguide (7) with changing width (G) undergo a change that also depends on the light's frequency. Therefore, the phase of light passing through such a phase shifter (6) is controlled over a wide frequency range. As shown in FIG. 6, different phase profiles can be obtained with a waveguide (7) whose width (G) and length (L) can be adjusted compared to waveguides with fixed widths. Thus, photonic neural networks using phase shifters (6) are optimized to provide the desired complex outputs. The parameters to be optimized here are the widths (G) of the waveguides (7) in the phase shifter (6) sections and their respective lengths (L). The number of these widths (G), which are optimization parameters, is determined by the user. As the number of parameters increases, it becomes easier to achieve structures that provide multi-functional optical outputs.

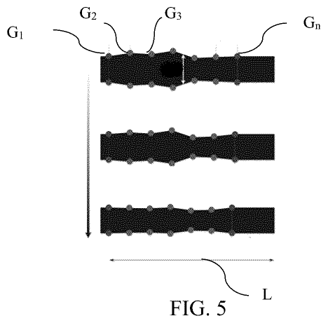

For the simulation and optimization of the photonic network, the optical responses of each coupler (5) and the effective indices of the waveguides (7) are pre-modeled without losing physical accuracy. To achieve any desired optical output from the photonic network, the parameters in the network are configured to provide the targeted function. First, the waveguides (7) with adjustable widths (G) present in the network are created with random widths. Then, the optical simulation of this network is quickly calculated using transfer matrices with pre-prepared models. The output obtained from this calculation is compared with the target output, and the widths (G) of the adjustable waveguides (7) are updated to reduce the difference between these two outputs. This process is iteratively continued as shown in FIG. 5 until the photonic network provides the target output. Here, the user can use any desired heuristic or gradient-based optimization technique. Preference for gradient-based optimization techniques allows the use of current artificial intelligence libraries.

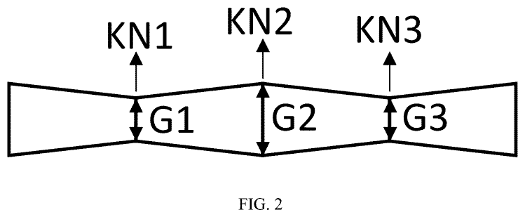

Optimizing the shape of the waveguide (7) means optimizing the widths (G) at different points along the waveguide (7). These points are referred to as control points (KN). For example, in FIG. 2, a waveguide (7) with three control points (KN), and therefore three optimizable widths (G), is shown. These widths are then optimized iteratively. The number of control points (KN) with widths (G), which are optimization parameters, is determined by the user. As the number of parameters increases, it becomes easier to achieve structures that provide multi-functional optical outputs.

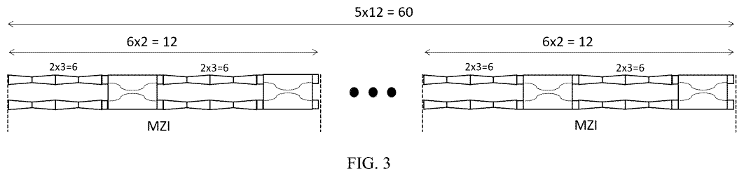

For example, if a photonic designer wants to design a broadband photonic coupler with two inputs and two outputs, aiming for the photonic signal (light) from the first or second input to be equally split into the two outputs, the designer might create a photonic network consisting of an interferometer layer (3) containing five Mach-Zehnder Interferometers (MZIs) with two inputs and two outputs. Suppose each phase shifter (6) in the Mach-Zehnder Interferometers (MZIs) has three control points (KN). Each phase shifter (6) consists of two waveguides (7), one lower and one upper, meaning there are 2×3-6 optimizable widths (G) per phase shifter. Since each Mach-Zehnder Interferometer (MZI) consists of a pair of phase shifters (6), and there are a total of five Mach-Zehnder Interferometers (MZIs), the total number of optimizable parameters is 6×2×5=60 (this two-port network is shown in FIG. 3). In this way, by optimizing these 60 different parameters (waveguide widths (G)), the desired device (1) can be obtained. In the optimization process of the photonic neural network processing device of the present invention (1), the 60 different widths (G) in the above example are initially created randomly, i.e., before optimization. During optimization, these widths (G) are increased or decreased in each iteration to achieve the desired result from the device. Based on this example, depending on different needs (number of parameters), a designer designing a photonic neural network processing device (1) could use an interferometer layer (3) containing more or fewer than five Mach-Zehnder Interferometers (MZIs). Similarly, the number of control points (KN) could be chosen as a number other than three. Thus, the designer is free to choose the number of parameters to achieve the desired device (1).

The photonic neural network processing device (1) of the present invention can have any desired number of input layers (2) and output layers (4) and any desired number of interferometer layers (3). The number of control points (KN) in the adjustable waveguides (7) in the interferometer layers (3) can be any desired number.

Thanks to the photonic neural network processing device (1) of the present invention, structures can be designed such that the power, phase, and propagation characteristics (dispersion) of the output optical signal are functions of the wavelength and polarization.

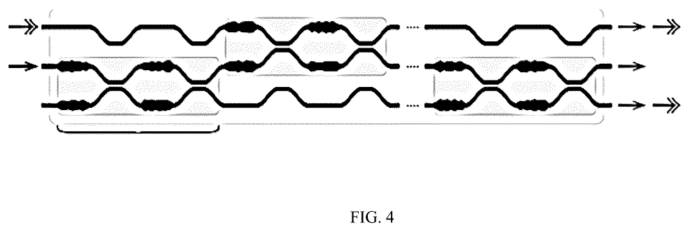

The photonic neural network processing device (1) of the present invention can perform multiple functions simultaneously, as shown in FIG. 4. In this example, the photonic network directs the signal coming into the first input to the first and third outputs while simultaneously distributing the signal coming into the second input among all three outputs. Similarly, the photonic network can be configured to perform multiple functions independently.

In an application of the integrated photonic neural network processing device (1) of the present invention, broadband desired-ratio couplers (5), spectral filters, polarization splitters, linear optical computing, and optical signal processing functions are configured to be performed.

In one application of the invention, the multi-functional integrated photonic neural network processing device (1) includes waveguides (7) with adjustable widths (G) and lengths (L) configured to perform multiple functions simultaneously, as shown in FIG. 4.

In another application, the multi-functional integrated photonic neural network processing device (1) of the present invention is of a recurrent type, connecting one or more output connections to one or more Mach-Zehnder Interferometers (MZIs) in the interferometer layer (3).

In another application, the multi-functional integrated photonic neural network processing device (1) of the present invention includes waveguides (7) made of any material suitable for integrated photonics, such as glass, silicon, silicon nitride, indium phosphide, or any other integrated photonic material.

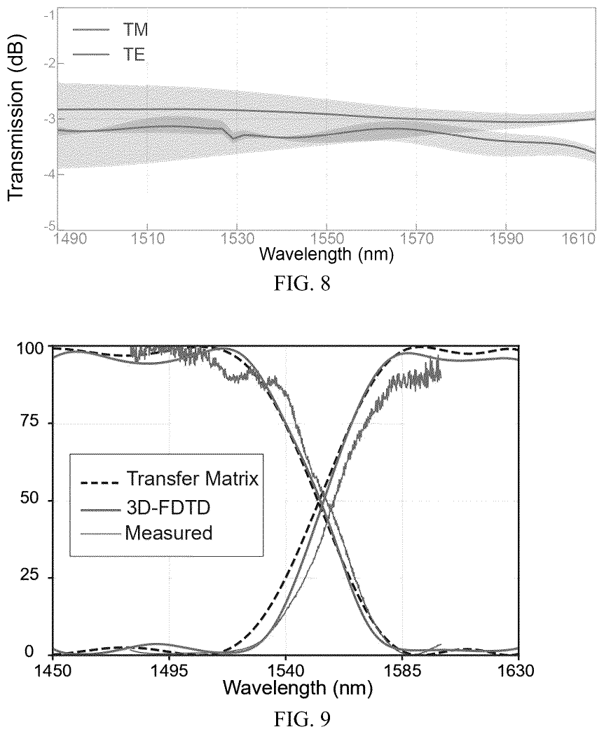

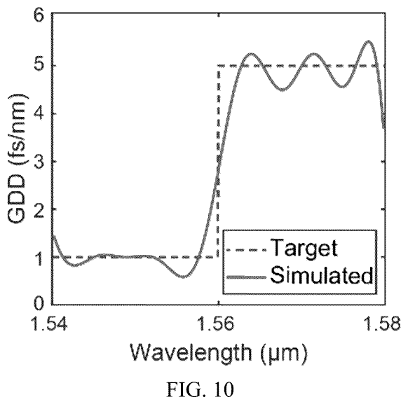

In another application in fabrication tolerant power distribution (8), the multi-functional integrated photonic neural network demonstrates robust power distribution capabilities even under fabrication variations. FIG. 8 plots the splitting imbalance from a 50% splitting ratio, illustrating how the network maintains balanced power distribution despite inconsistencies introduced during manufacturing. This fabrication tolerance is crucial for ensuring reliable performance in practical applications where manufacturing deviations are unavoidable. Furthermore, polarization-agnostic power splitting (9) highlights the device's ability to evenly split light across different polarization states. Electric field intensity distributions recorded from 3D-FDTD simulations for both Transverse Electric (TE) and Transverse Magnetic (TM) polarizations at wavelengths of 1500 nm and 1600 nm confirm that light is consistently and evenly split between the two output ports for both polarization states. This polarization-independent performance ensures that the network can effectively handle diverse optical signals without degradation in performance, enhancing its versatility and applicability in various photonic systems.

In spectral duplexer (10), the performance of the spectral duplexer (10) is validated through a comparative analysis of normalized transmission spectra for the fabricated and experimentally measured duplexer (10), alongside simulated transfer matrix and 3D-FDTD results. This figure demonstrates the duplexer's (10) precision in separating and routing different spectral components, affirming the accuracy of both the design and simulation models. The excellent agreement between experimental measurements and theoretical simulations underscores the device's reliability and effectiveness in practical scenarios. Additionally, a step-like dispersion profile (11) achieved by the photonic neural network processing device (1) showcases the implementation of a step-like dispersion profile within a 3-port network of the photonic neural network. The optimized step-like dispersion characteristics, achieved through meticulous waveguide dimension adjustments, illustrate the network's capability to engineer specific dispersion profiles essential for communications and sensing applications. These tailored dispersion profiles facilitate enhanced signal integrity and data transmission performance, making the network highly suitable for high-speed communication systems where precise dispersion control is paramount.

The multi-functional integrated photonic neural network processing device (1) of the present invention is configured to perform operations according to deep learning algorithms and artificial intelligence.

1. A multi-functional integrated photonic neural network processing device, comprising:
an input layer consisting of a series of waveguides configured to receive incoming optical signals,
an interferometer layer connected to the input layer comprising Mach-Zehnder Interferometers (MZIs) configured to apply linear transformations to a series of optical signals received from an input,
an output layer connected to the interferometer layer comprising a series of waveguides configured to direct the optical signals from the interferometer layer to an output,
each MZI comprising a pair of couplers and a pair of phase shifters,
each phase shifter comprising a waveguide with an adjustable width and an adjustable length, wherein each phase shifter comprises a waveguide with an adjustable width and an adjustable length.

2. The multi-functional integrated photonic neural network processing device according to claim 1, wherein the phase shifter comprises waveguides with control points having adjustable widths between 350 nanometers and 700 nanometers, allowing for an effective index to effectively change, and adjustable lengths from 6 micrometers to 10 micrometers as a continuous variable to increase a degree of freedom to control phase mismatch between arms of the MZI, according to a gradient-based optimization algorithm suitable for user's needs, comprising a realization of complex optical power distributions, polarization-aware optical input/output signal mapping or custom dispersion profiles and optimization parameters comprising number of cascaded MZIs, random initialization methods of the adjustable widths and lengths of the phase shifters.

3. The multi-functional integrated photonic neural network processing device according to claim 1, comprising:
an input layer with a plurality of inputs and outputs,
an output layer with a plurality of inputs and outputs,
at least one interferometer layer, and
phase shifters in the interferometer layers with a plurality of control points having adjustable widths and adjustable lengths;
wherein the waveguides in the phase shifters are configured to encode specific phase profiles at each interferometer layer via an arrangement of at least two width values of waveguide segments of the phase shifters, resulting in an achievement of use cases comprising triangular or step-like dispersion profiles, to achieve desired dispersion engineering; additional to a realization of custom dispersion profiles, user-specified power splitting objectives in a polarization-agnostic or polarization-aware manner are achieved by utilization of custom phase profiles originated by the phase shifters and waveguides with different path lengths, considering a plurality of types of optical objectives that provides ability to route light to the output layer through the interferometer layers as a function of wavelength and input layer's configuration.

4. The multi-functional integrated photonic neural network processing device according to claim 1, wherein the multi-functional integrated photonic neural network processing device is configured to perform functions comprising broadband desired-ratio couplers, spectral filters, polarization splitters, linear optical computing, and optical signal processing in a broadband wavelength range between 1200 nanometers and 1700 nanometers.

5. The multi-functional integrated photonic neural network processing device according to claim 1, wherein adjustable-width and adjustable-length waveguides are configured to perform a plurality of functions simultaneously, due to discretized calculation of overall phase profiles of the phase shifters using a spline fit or linearly changing widths along corresponding tapers, as a function of a placement of optical input source on the input layer whose optical transformation matrix gets updated resulting in a different input/output mapping observed in the output layer.

6. The multi-functional integrated photonic neural network processing device according to claim 1, wherein the multi-functional integrated photonic neural network processing device is of a recurrent type, connecting at least one output connection to at least one MZI in the interferometer layer, providing a loop-like route for light to propagate until a desired optical functionality at the output layer is achieved.

7. The multi-functional integrated photonic neural network processing device according to claim 1, wherein the waveguides are made of materials suitable for integrated photonics, comprising glass, silicon, silicon nitride, or indium phosphide as a proposed methodology remains independent of a fabrication constraints and material properties of a targeted integrated photonic devices.

8. The multi-functional integrated photonic neural network processing device according to claim 1, wherein the multi-functional integrated photonic neural network processing device is configured to perform operations according to deep learning algorithms and artificial intelligence, due to an ability to perform multiply-accumulate (MAC) operations with high efficiency.

9. A method for a multi-functional integrated photonic neural network processing device, comprising steps of:
creating waveguides in a photonic network with random widths,
calculating an optical simulation of the photonic network using transfer matrices with pre-created models for each component in the photonic network,
comparing an output obtained from a calculation with a target output,
increasing or decreasing widths of the adjustable waveguides to reduce a difference between the calculated output and the target output,
continuing a process of increasing or decreasing the widths of the adjustable waveguides iteratively until the photonic network provides the target output, comprising using a gradient-based or heuristic-based optimization technique to automatically optimize waveguide dimensions for polarization handling and dispersion engineering.

10. The method according to claim 9, comprising using the gradient-based or heuristic-based optimization technique to achieve a small difference between a desired optical output profile and a realized optical functionality by scanning a set of possible width and length values of phase shifters iteratively.

11. A multi-functional integrated photonic neural network processing device, wherein the multi-functional integrated photonic neural network processing device is configured to perform functions comprising broadband polarization-agnostic power splitting, broadband randomly-ratio-dependent couplers, and spectral filters, as described in claim 1, both as a function of wavelength and polarization of input optical source.

12. A multi-functional integrated photonic neural network processing device, wherein the multi-functional integrated photonic neural network processing device is configured to create desired dispersion profiles comprising triangular, step, or linear dispersion profiles, for communications, sensing, and computational applications, as described in claim 1.

13. A method for designing photonic devices achieving fabrication-tolerant power distribution, comprising:
the multi-functional integrated photonic neural network processing device according to claim 1 to ensure photonic devices are designed to be tolerant to fabrication variations,
optical models with variation awareness into a design process to account for possible fabrication-induced deviations, comprising width and height variations, of the phase shifters and the couplers,
virtual wafer maps to calculate effects of layout-dependent fabrication variations on photonic device performance,
optimizing the widths of the adjustable waveguides to enhance a robustness of photonic devices against fabrication-induced width and height variations.

14. The multi-functional integrated photonic neural network processing device according to claim 2, comprising:
an input layer with a plurality of inputs and outputs,
an output layer with a plurality of inputs and outputs,
at least one interferometer layer, and
phase shifters in the interferometer layers with a plurality of control points having adjustable widths and adjustable lengths;
wherein the waveguides in the phase shifters are configured to encode specific phase profiles at each interferometer layer via an arrangement of at least two width values of waveguide segments of the phase shifters, resulting in an achievement of use cases comprising triangular or step-like dispersion profiles, to achieve desired dispersion engineering; additional to a realization of custom dispersion profiles, user-specified power splitting objectives in a polarization-agnostic or polarization-aware manner are achieved by utilization of custom phase profiles originated by the phase shifters and waveguides with different path lengths, considering a plurality of types of optical objectives that provides ability to route light to the output layer through the interferometer layers as a function of wavelength and input layer's configuration.

15. The multi-functional integrated photonic neural network processing device according to claim 2, wherein the multi-functional integrated photonic neural network processing device is configured to perform functions comprising broadband desired-ratio couplers, spectral filters, polarization splitters, linear optical computing, and optical signal processing in a broadband wavelength range between 1200 nanometers and 1700 nanometers.

16. The multi-functional integrated photonic neural network processing device according to claim 3, wherein the multi-functional integrated photonic neural network processing device is configured to perform functions comprising broadband desired-ratio couplers, spectral filters, polarization splitters, linear optical computing, and optical signal processing in a broadband wavelength range between 1200 nanometers and 1700 nanometers.

17. The multi-functional integrated photonic neural network processing device according to claim 2, wherein adjustable-width and adjustable-length waveguides are configured to perform a plurality of functions simultaneously, due to discretized calculation of overall phase profiles of the phase shifters using a spline fit or linearly changing widths along corresponding tapers, as a function of a placement of optical input source on the input layer whose optical transformation matrix gets updated resulting in a different input/output mapping observed in the output layer.

18. The multi-functional integrated photonic neural network processing device according to claim 3, wherein adjustable-width and adjustable-length waveguides are configured to perform a plurality of functions simultaneously, due to discretized calculation of overall phase profiles of the phase shifters using a spline fit or linearly changing widths along corresponding tapers, as a function of a placement of optical input source on the input layer whose optical transformation matrix gets updated resulting in a different input/output mapping observed in the output layer.

19. The multi-functional integrated photonic neural network processing device according to claim 4, wherein adjustable-width and adjustable-length waveguides are configured to perform a plurality of functions simultaneously, due to discretized calculation of overall phase profiles of the phase shifters using a spline fit or linearly changing widths along corresponding tapers, as a function of a placement of optical input source on the input layer whose optical transformation matrix gets updated resulting in a different input/output mapping observed in the output layer.

20. The multi-functional integrated photonic neural network processing device according to claim 2, wherein the multi-functional integrated photonic neural network processing device is of a recurrent type, connecting at least one output connection to at least one MZI in the interferometer layer, providing a loop-like route for light to propagate until a desired optical functionality at the output layer is achieved.
